(19) United States
(12) Patent Application Publication
(10) Pub. No.: US 2023/0046090 A1
(43) Pub. Date: Feb. 16, 2023

(54) CLOSURE FOR A MULTI-USE DRINKS BOTTLE

(71) Applicants: James Grant, Surrey (GB); BW TECHNOLOGIES LTD, Crondall Hampshire (GB)

(72) Inventors: James Grant, Farnham Surrey (GB); Jon Grant, Crondall Hampshire (GB)

(21) Appl. No.: 17/791,988

(22) PCT Filed: Jan. 11, 2021
(86) PCT No.: PCT/EP2021/050348

§ 371 Date: Jul. 11, 2022

(30) Foreign Application Priority Data
Jan. 10, 2020 (GB) 2000357.0

(51) Int. Cl. A45F 3/16; B01D 39/20; B65D 47/08; B65D 47/32; B65D 51/16; B65D 51/24; C02F 1/00

(52) U.S. Cl. CPC A45F 3/16; B01D 39/2041; B01D 39/2082; B65D 47/0804; B65D 47/0885; B65D 47/32; B65D 51/1622; B65D 51/1644; B65D 51/24; C02F 1/002; C02F 2307/02; A45F 2003/163; B01D 2239/025

(57) ABSTRACT

A closure and filter for a multi-use water bottle. The closure has a main body having an outlet through which fluid passes to be consumed by the user and an air valve remote from the outlet to provide an air channel through the closure distinct from the fluid outlet to allow flow of air into the bottle as fluid passes through the outlet.

### FIELD OF INVENTION

The present invention relates to a closure for a multi-use water bottle.

### BACKGROUND TO THE INVENTION

The unprecedented growth in the production of plastics over many years has triggered a global environmental crises. One of the major contributors has been the use of single use plastic water bottles. In recent years there has been a significant push to reduce, and ultimately eliminate, plastic water bottles.

One problem associated with this change is that the consumers have become accustomed to drinking from plastic water bottles and are used to being able to compress the walls of the bottles to allow continuous sucking of water from them, this makes the convenient for continuous drinking whilst on the move. Such use is not possible with hard-skinned bottles without the use of a straw extending into the bottle.

Multi-use water bottles come in all sorts of shapes and sizes.

The majority of water bottles, used for example to carry water whilst taking part in sporting activities, comprise a flexible structure with an outlet usually built into a cap. Water is transferred to the mouth of the user when the bottle is squeezed.

Such bottles require an air valve to draw air back in to the bottle to equalise the pressure after it has been squeezed. The valve is usually built into the mouthpiece of the bottle. As the mouthpiece also provides the fluid outlet, bottles are invariably prone to leakage as air is drawn into the bottle causing turbulence which in turn draws droplets of liquid back through the valve. Whilst this does not tend to cause a large flow of liquid out of the bottle, unless the air valve is left open, the leakage is nevertheless often sufficient to dampen contents of the sports bag in which it is often carried or stored, which are often clothes, making them unpleasant to wear.

Another common use of water bottles is by children whilst attending school. A small leakage from the valve of a water bottle in a child's school bag is often enough to ruin school work carried in the bag, which is a common problem often faced by infuriated parents.

Takeaway coffee cups include an aperture in the removable plastic lid of the cup. Often the aperture is not clearly formed making it difficult to drink the contents without removing the lid. It is common for people to use an implement, such as pen for example, to increase the size of the aperture to allow sufficient air to enter the cup to equalize the pressure. However, once a larger aperture is formed, even the slightest jolt or movement is sufficient to spill the contents of the cup if it is still reasonably full. Furthermore, it is not possible to re-use the cup without severe spillage.

More recently there has been a trend for rigid structure water bottles made, for example, from hard plastic, stainless steel or aluminium. The rigid structure allows for greater personalisation or artistic designs to be printed on the outer surface of the bottle. As they cannot be squeezed, hard structure bottles rely on the consumer tipping the bottle upside down using gravity to consume the contents unless a straw is used. Straws have themselves been linked to environmental pollution as until recently they have also been made from plastic.

The present invention seeks to overcome the aforementioned problem by providing a closure for a multi-use water bottle which includes at least one air valve remote from the outlet to provide continuous equalisation air pressure within the bottle as the contents are consumed.

By “remote” it is meant that the passage of air is not in fluid connection with the passage of water to the extent that the passages are entirely separate.

A further problem is the perception with the general public that bottled water is purer and cleaner than normal water taken from a tap to the extent that it is often the case that people will continue to purchase plastic bottles of water and use them to fill up their multi-use water bottles.

The present invention also seeks to alleviate this problem by providing a filter attachable to the bottom of the closure through which fluid passes before leaving the outlet for consumption.

### STATEMENT OF INVENTION

According to a first aspect of the invention there is provided a closure for a multi-use water bottle the closure comprising a main body having an outlet through which fluid passes to be consumed by the user, the closure body having at least one air valve remote from the outlet to provide an air channel through the closure distinct from the fluid outlet to allow flow of air into the bottle as fluid passes through the outlet.

Preferably, the or each air valve is a one-way valve.

Preferably, the or each air valve is a duck-bill valve.

Preferably, the or each air valve sits within a respective aperture formed in a ceiling of the closure.

Preferably, the or each apertures are formed in a recess within the ceiling.

Preferably, the closure further comprises a grill plate extending over the or each valve and the recess.

Preferably, the closure further comprises a baffle plate extending across the closure under the or each valve.

Preferably, the baffle plate is ring-shaped and sits around the outlet between the outlet and the wall of the closure.

Preferably, the closure further comprises a lid hingedly attached to the main body, wherein the lid includes sealing means on its inside surface to overlay the outlet and the or each air channel aperture when the lid is closed to prevent seepage of liquid or air from the closure.

Preferably, the closure further comprises a filter attachable to the closure such that the filter extends from the base of the outlet into the bottle.

Preferably, the filter comprises a pleated sheet housed within a tubular casing.

Preferably, the sheet is made from alumina nanofibers.

According to a second aspect of the invention, there is provided a bottle having a closure according to the first aspect.

According to a third aspect of the invention, there is provided a filter for attachment to a closure according to the first aspect.

### BRIEF DESCRIPTION OF THE DRAWINGS

One embodiment of the invention will now be described by way of example only, with reference to the accompanying figures in which:

FIG. 1 illustrates a closure for a multi-use drinking bottle constructed in accordance with the invention;

FIG. 2 is a view of the closure of FIG. 1 with a lid closed;

FIG. 3 is a further view of the closure of FIG. 1;

FIG. 4 illustrates a filter for use with the closure of FIG. 1;

FIG. 5 is view if the filter attached to the closure;

FIG. 6 shows the separate components of the filter;

FIG. 7 shows the closure on a bottle;

FIG. 8 is a perspective view of the bottle of FIG. 6 shows its underside;

FIG. 9 is a plan view of the closure body;

FIG. 10 is a further plan view of the closure body of FIG. 8 with the top layer removed;

FIG. 11 is a further plan view of the closure body of FIG. 8 with a further layer removed;

FIG. 12 is a further plane view of the closure body of FIG. 8 with the top removed, showing the baffle plate;

FIG. 13 is a perspective view of the underside of the closure body;

FIG. 14 is a perspective view of the underside of the closure lid; and

FIG. 15 is a cross-section view of the closure and filter on a bottle.

### DETAILED DESCRIPTION OF PREFERRED EMBODIMENTS

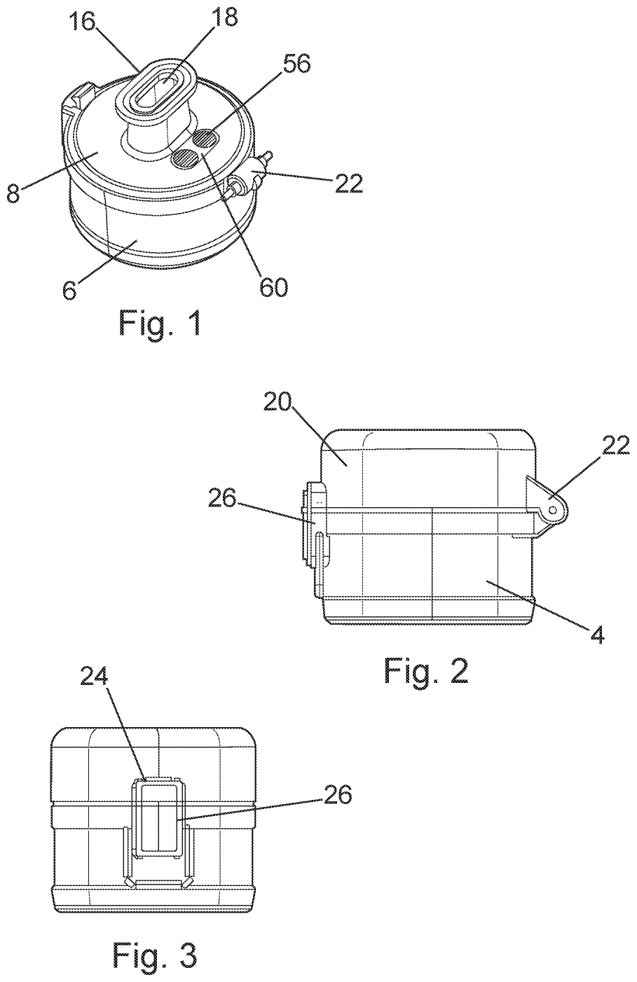

A closure for a multi-use water bottle 2 is shown in FIG. 1. In the described embodiment, the water bottle is a hard, double-skin bottle made from stainless steel. It is appreciated though that the water bottle may have any suitable construction and be made from other suitable materials known for multi-use bottles with a generally inflexible main body structure.

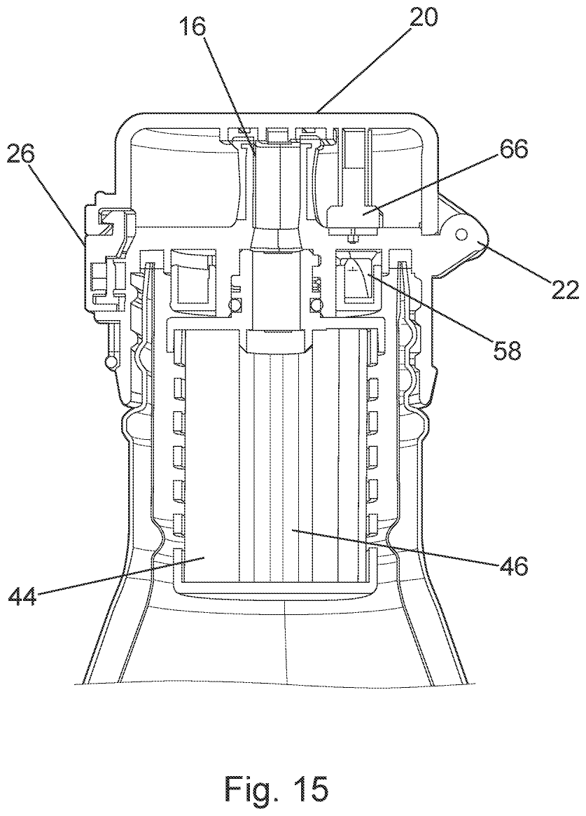

The closure has a main body 4 that is generally cylindrical with a side wall 6 and a flat ceiling 8. As can be seen in FIGS. 13 and 15, the side wall 6 carries an internal thread 10 to engage with an external thread 12 on the neck 14 of the bottle 2.

Upstanding from the ceiling 8 of the closure is a funnel-shaped outlet 16, with an aperture 18 through which water passes to be consumed by the user. The outlet 16 is made from a silicone rubber or similar flexible material suitable to allow the funnel 16 to be placed comfortably in the mouth of the user and for water or other liquid contents to be sucked upwardly through it by the user.

As can be seen in FIGS. 2 and 3, the main body 4 is coverable by a lid 20 attached to one side of the main body 4 by a hinge mechanism 22. The lid is not shown attached in FIG. 1.

The opposing side of the main body 4 has a simple locking mechanism in the form of a clasp 24 to clip over a locking protrusions 26 in the lid and closure 4 to secure the lid 20 and cover the outlet 16 when consumption of the liquid content is not required. The clasp 24 is pivoted upwardly to clip and hold the locking protrusions 26 in an engaged manner.

The locking protrusions 26 may provide a convenient surface for branding of the product.

As can also be seen most clearly in FIG. 14, the internal top surface 28 of the lid 20 has a sealing member 30 extending outwardly therefrom and shaped complimentary to the outlet 16 to abut and cover the outlet 16 in a sealed manner when the lid 20 is closed, thereby preventing any leakage through the outlet 16 at such time.

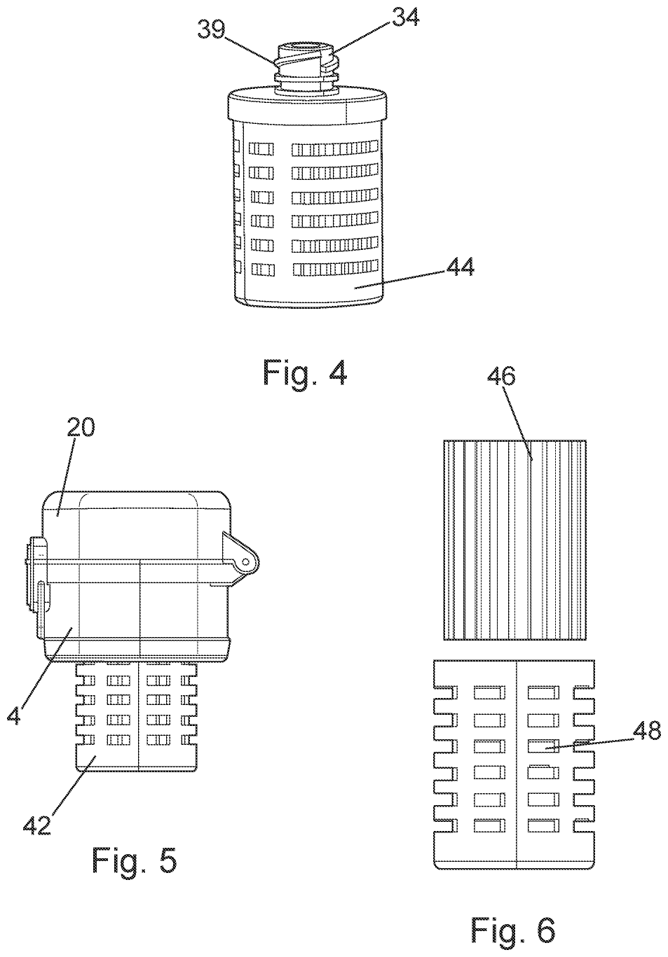

As can be seen in FIG. 13, the inside top surface 32 of the closure body 4 includes a downwardly extending tubular connector 34 with a throughbore 36, extending through the closure ceiling 8 to the outlet 16. The internal wall of the throughbore carries a thread 38 to receive a complimentary thread 39 of a hollow, tubular connector 40 of a filter 42 (shown in FIG. 4).

As can be seen best in FIG. 6, the filter 42 comprises a substantially cylindrical casing 44 housing a pleated paper filter material 46.

An example of a suitable filter medium and its construction is disclosed in the applicant's patent application PCT/EP2019/069589. The filter, used in many of the applicant's products, consists of alumina nanofibers. The filter material is made up of very small fibres made from aluminium metal or aluminium containing materials. The filter material is provided in sheet form and is pleated to increase surface area.

The material is incorporated by being placed within and around the internal wall of the tubular mechanical filter casing 44 such that, in use, untreated water is pulled through apertures 48 in the filter casing 44, and then through the alumina nanofiber sheet 46 by the sucking action user. Filtered water is then drawn through the connector throughbore 36 and out of the outlet 16.

This above mechanism ensures that water or liquid cannot leave the bottle without first traveling through the filter 42.

The filter may be of any other type suitable for use with liquids for consumption. Equally, it could filter other media (for example solid or partially solid) as well as liquid.

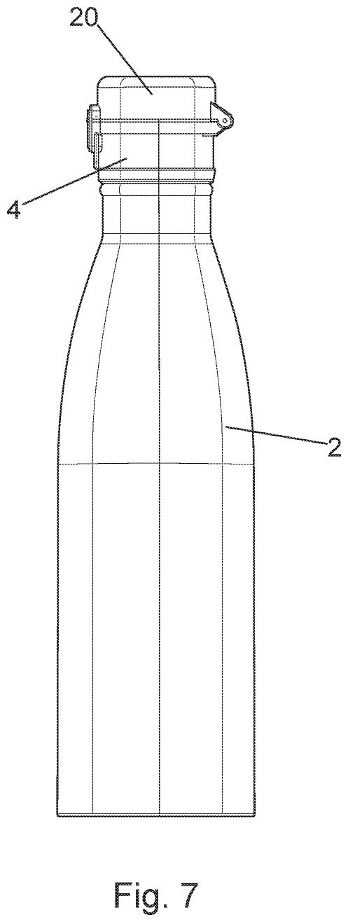

FIG. 7 shows the closure on a bottle 2. The filter 42 extends downwardly into the bottle 2 to locate within its neck area.

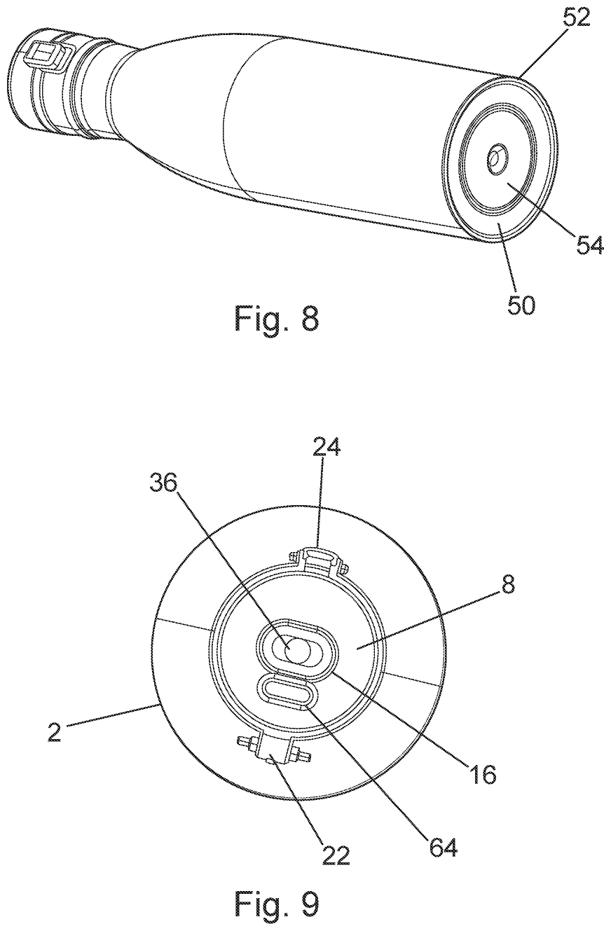

FIG. 8 shows the underside of the bottle. It can be seen that the base 50 of the bottle 2 is recessed to form a rim 52 around its periphery. The outer face of the base 50 has a non-metallic coating.

An NFC (Near-Field Communication) and RFID (Radio-Frequency Identification) microchip or tag may be secured to the outer (bottom) face of the base 50. The tag and base 50 may then be overlaid with a hydrophilic polymer coating. To this end, the tag sits in a centrally located generally circular recess 54. Only the recessed area 54 is covered by the polymer coating avoiding the need to coat the entire base 50.

A rubber pad may then be fitted and secured over the outer face of the base 50, overlaying the tag, to fit within the confines of the inner walls of the rim 52 so to sit flush with the bottom of the bottle casing.

The outer (bottom) surface of the pad may be formed with ridges or protrusions to provide grip to a surface on which the bottle is placed. The ridges or protrusions may be in the form of product information or branding.

The fact that the body of the bottle 2 is made from metal, preferably high grade stainless steel, and the NFC tag is adhered to the underside of the bottle base 50 i.e. outside the bottle, ensures that the magnetic field is concentrated and directed downwardly and from the bottle to allow the NFC tag to be readily and efficiently by simply placing a reading device, for example, a smart phone under the base 50—the area being easily identifiable as being the circular rubber pad visually separate to the bottle structure, or by “scanning” the base 50 of the bottle over a reading device available at “water station” or water source.

FIG. 8 is an aerial plan view of the ceiling 8 of the closure body 4. In this figure, the lid 20 has been disconnected from the hinge mechanism 22. It can be seen that the ceiling 8 of the closure body 4 has two distinct apertured areas. The first is at the base of the outlet 16 at the bottom of the throughbore 36 and leading into the connector of the filter 42 and subsequently into the centre of the filter 42. The second area provides two apertures 56, each of which provide a valved air channel through the closure body 4 as will be now described.

The apertures 56 define a passage through the closure 4 remote from the fluid outlet 16 so that only air, and no fluid, passes through the air apertures 56.

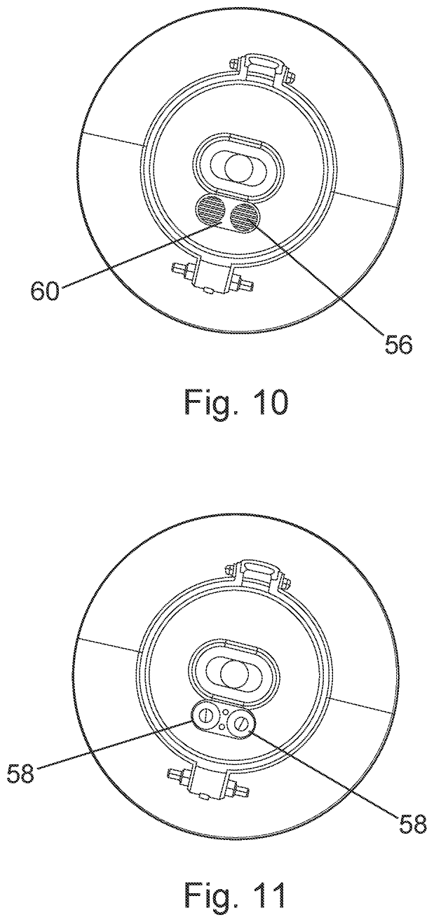

As can be seen in FIG. 10, two duck-bill valves 58 sit within each aperture 56. The valves 58 extend downwardly into the closure 4 such that the valves 58 are at their most narrow within the closure 4 so to allow atmospheric air to enter the closure 4 and flow into the bottle 2 to equalise the pressure therein as fluid is sucked from the bottle 2 by the user, whilst preventing air from travelling upwardly out of the bottle through the air apertures 56, as the ends of the valves 58 close together when upward pressure is experienced, whereas the ends part from one another when downward pressure is experienced. The duck-bill valves 58 therefore act as non-return air valves.

A grill plate 60 is located over the valves 58, as is shown in FIG. 10. The grills 60 help to direct and control the air flow into the closure 4 and ensure that the valves, to ensure they work as efficiently as possible.

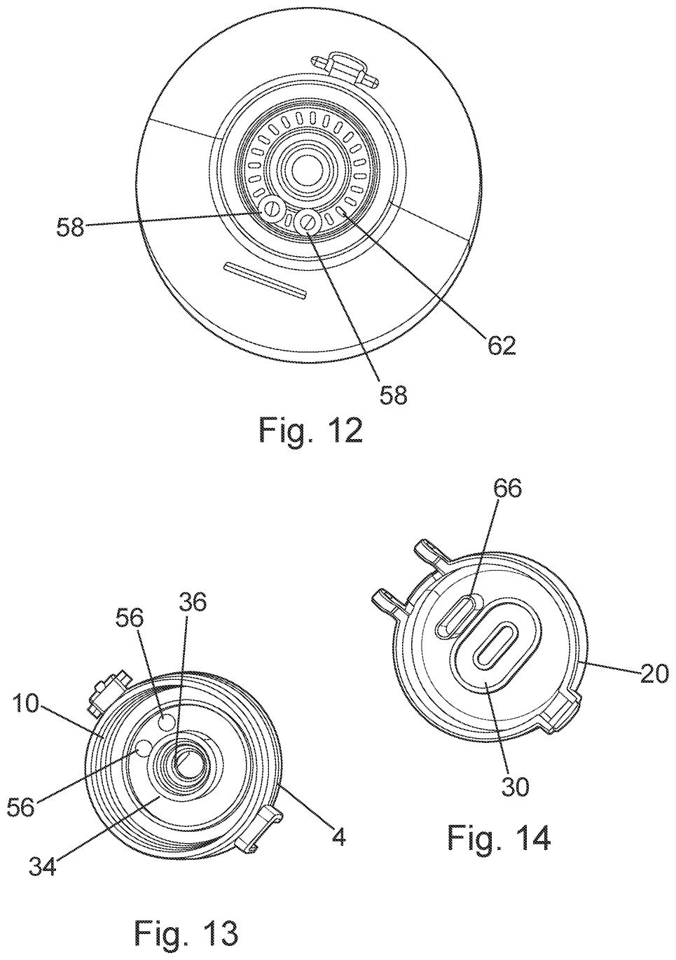

As can be seen in FIG. 12, a ring-shaped baffle plate 62 is provided around the base of the outlet 16 and extends between the outlet 16 and the internal wall of the closure body 4. The baffle plate 62 protects the valves 58 from water turbulence. Moreover, the baffle plate 62 has the effect of stopping the “whistling” sound of returning air as it prevents water droplets from settling on the valves 58. Finally, the baffle plate 62 obscures the valves 58 from view and prevents them from accidental or deliberate damage.

The air channels through the closure ceiling 8 are formed within a lozenge-shaped recess 64 in the ceiling 8. The recess 64 receives the walls of a complimentary shaped protrusion 66 extending outwardly from the inside surface 28 of the lid 20 to form a seal over the air channels apertures when the lid 22 is closed over the closure body 4.

When the lid is closed both the fluid outlet 16 and the air channels 56 are sealed thereby to prevent any fluid or air leakage.

1. A closure for a multi-use water bottle, comprising a main body having an outlet through which fluid passes to be consumed by the user, the closure body having at least one air valve remote from the outlet to provide an air channel through the closure distinct from the fluid outlet to allow flow of air into the bottle as fluid passes through the outlet, and a ring shaped battle plate under the at least one air valve and around the fluid outlet between the outlet and a wall of the closure.

2. The closure according to claim 1, wherein the at least one air valve is a one-way valve.

3. The closure according to claim 2, wherein the at least one air valve is a duck-bill valve.

4. The closure according to any one of claim 1, wherein the at least one air valve sits within a respective aperture formed in a ceiling of the closure.

5. The closure according to claim 4, wherein the at least one aperture is formed in a recess within the ceiling.

6. The closure according to claim 5, further comprising a grill plate extending over the at least one air valve and the recess.

7. (canceled)

8. (canceled)

9. The closure according to claim 1, further comprising a lid hingably attached to the main body, wherein the lid includes sealing means on its inside surface to overlay the fluid outlet and the at least one aperture when the lid is closed to prevent seepage of liquid or air from the closure.

10. The closure according to claim 1, further comprising a filter attachable to the closure such that the filter extends from the base of the outlet into the bottle.

11. The closure according to claim 10, wherein the filter comprises a pleated sheet housed within a tubular casing.

12. The closure according to claim 11, wherein the sheet is made from alumina nanofibers.

13. (canceled)

14. (canceled)
